(19) United States
(12) Patent Application Publication
(10) Pub. No.: US 2019/0183067 A1
(43) Pub. Date: Jun. 20, 2019

(54) Topiary System

(71) Applicant: Anthony Limon, Rancho Cucamonga, CA (US)

(72) Inventor: Anthony Limon, Rancho Cucamonga, CA (US)

(21) Appl. No.: 16/223,684

(22) Filed: Dec. 18, 2018

Related U.S. Application Data
(60) Provisional application No. 62/608,150, filed on Dec. 20, 2017.

(51) Int. Cl. A01G 9/12

(52) U.S. Cl. CPC A01G 9/12

(57) ABSTRACT

A user-assembled topiary structure having a body and engageable appendages formed of rigid mesh adapted for plant growth thereon and therethrough. The topiary structure is customizable to differing shapes by the user who can choose from various kits of appendages which are engageable to the body portion to change it to the shape of a different object or animal. The components forming the body portion and appendages are all stackable within one half section of the body portion for easy shipping and storage.

This application claims priority to U.S. Provisional Patent Application Ser. No. 62/608,150 filed on Dec. 20, 2017, which is incorporated herein in its entirety by this reference thereto.

### BACKGROUND OF THE INVENTION

### 1. Field of the Invention

The present invention relates generally to topiary frames. More particularly, it relates to a topiary frame configured from a kit of removably engageable components. The components in disassembled form will substantially all nest or fit within the confines of one half portion of the largest component in the kit of components, thereby allowing for compact shipping and customized user assembly to a desired topiary shape in any of a plurality of configurations.

### 2. Prior Art

Topiary is the horticultural practice of training perennial plants to develop and maintain clearly defined shapes. These shapes can be geometric or fanciful or, more modernly, can resemble the three dimensional shapes of various animals.

In the art of topiary, the plants of choice are trained and urged to grow in the desired shape by clipping the foliage and twigs of trees, shrubs and subshrubs to develop and maintain the desired eventual shape. To aid in this plant growth shaping endeavor, shaped wire cages are sometimes employed in modern topiary to provide a shaped structure for the plant to grow upon, and to guide untutored shears during trimming of the growing plant over time, to continuously urge it to assume the shape of choice, which would be the shape of the wire cage.

Conventional topiary frames of three dimensional objects or animals are formed of a wire or synthetic mesh, which is shaped into the shape of the desired three dimensional object or animal or the like. However, because conventional topiary frames are formed in this fashion, they tend to be very large and ungainly. Conventionally, such frames are formed on-site if a large truck to transport them is unavailable.

Further, conventional topiary structures are generally unitary in nature because the mesh portion is shaped to the dimensions of the desired object or animal and permanently engaged to a skeletal structure or frame which provides the support for the weight of the mesh, as well as the eventual weight of the plant once intertwined with the mesh portion.

As a consequence, in addition to being large and expensive to ship and transport, each topiary structure is formed in a final three dimensional structure and offers the user on site no option to customize or adjust it. As such, there are no options for topiary structure employable by users wishing to customize it on site or for manufacturers who wish to increase sales by providing topiary structures which are shipped in small packages and which can be customized to multiple shapes using provided kit components for the topiary structure.

The topiary system herein provides a user-assemblable topiary structure which is easily assembled from a kit of topiary components. The components provided initially, or available by subsequent purchase, allow each user to customize the shape of their assembled topiary to any of a plurality of different animal or object shapes. Such is accomplished using a torso and head portion adapted to nest within separated halves thereof. The torso and head portion, once assembled, are engageable with any chosen appendage components from a kit of such. All of the torso halves and appendage components are adapted for easy on site assembly to each other.

The topiary system herein, by provision in assembled kit form, further provides manufacturers the option to provide multiple shapes which can be formed by buyers from a kit of topiary components. Such a kit is formed of a base body portion and a plurality of engageable head and limb members. All engageable body, limb, and head components themselves disengage into sections which nest into themselves. The nested appendage portions all are configured to nest within the larger body section. This configuration not only allows for easy on site assembly by a user, and easy customized ordering of preferred shapes of the device, it also provides compact shipping of the dissembled components. This nesting configuration significantly reduces the volume of the packaging and the freight costs to the buyer which are generally calculated by weight and volume of the shipped package.

It should be noted, the foregoing examples of related art for topiary structures and the like and limitations related therewith are intended to be illustrative and not exclusive, and they do not imply any limitations on the topiary system described and claimed herein. Various limitations of the related art are already known or will become apparent to those skilled in the art upon a reading and understanding of the specification below and the accompanying drawings.

An object of the present invention is the provision of a user-assemblable topiary structure formed from user-chosen components from kit of such components, which allows users to form a topiary structure in any of a plurality of three dimensional shapes using the chosen engageable components.

Further objectives of the topiary system herein will be brought out in the following parts of the specification wherein the summary and detailed description of the invention are for the purpose of fully disclosing the invention without placing limitations thereon.

### SUMMARY OF THE INVENTION

The present invention provides a device and method solving shortcomings and dilemma in the art of topiary structures through the provision of a user-assemblable topiary structure in a user chosen three dimensional shape using chosen engageable components provided in a kit.

The kit features an assemblable body portion formed of pair of engageable body half sections, which have a three dimensional form of choice. Each of the body half sections have mating fasteners thereon in registered positions to properly position both half sections when engaged to form a three dimensional body portion.

This body portion formed of half sections includes apertures communicating through the mesh forming each half section. The apertures are each configured with mating fasteners on the apertures which are in registered positions to engage mating fasteners located on assembled limbs thereto. The limbs are each formed from mirrored shaped half sections from a kit of such, to form the assembled topiary figure in the shape desired by a user.

A head section of the body portion is adapted with first mating connectors in registered positions on the head portion. These first connectors, so positioned, properly locate any of a chosen plurality of head-engageable components, to properly position them on the assembled structure to complete the shape with for example ears and a nose or trunk on the head portion.

The body half sections are mirrored in shape, which allows for a nesting stacking of the two half sections of the body portion, for shipment and storage. Each of the attachable limbs and head attachments also are configured from two half sections which are also mirrored in shape. Such allows the half sections of the limbs and head attachments to also stack in a nesting configuration which significantly reduces their three dimensional footprint during shipment and storage.

Further, the attachable limbs and head attachments stacked in a nesting configuration, will all fit within a curved interior recess of the nested body half sections. Such allows all of the components from a kit of components to form a chosen topiary structure, to ship in a container having an interior cavity equal to or just slightly larger than the volume needed to ship one half section of the body portion of the device. This nesting stacking of all components significantly decreases shipping costs which are conventional based on volume and weight. Further, it significantly decreases the containers used for shipping a topiary structure which is environmentally friendly in that such reduces the amount of trash deposited into landfills by reducing the packaging requirements of the device herein.

Still further, the apertures provide easily accessible pathways between the interior cavity of the assembled body portion, and axial passages of the attached limbs such as arms, legs, and the like. This is especially preferred to allow the user to easily position water conduits and wiring and lighting onto the entire assembled topiary structure without having to cut holes in the body portion where limbs have been attached is done conventionally.

With respect to the above description, before explaining at least one preferred embodiment of the herein disclosed user assembled topiary structure system and method in detail, it is to be understood that the invention is not limited in its application to the details of construction and to the arrangement in the following description or illustrated in the drawings. The topiary system herein described is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for the designing of other topiary structures assembled from kit components and for carrying out the several purposes of the present disclosed system. It is important, therefore, that the claims herein be regarded as including such equivalent construction and methodology, insofar as they do not depart from the spirit and scope of the present invention.

### BRIEF DESCRIPTION OF DRAWING FIGURES

The accompanying drawings, which are incorporated herein and form a part of the specification, illustrate some, but not the only or exclusive examples of embodiments and/or features of the invention. It is intended that the embodiments and figures disclosed herein are to be considered illustrative rather than limiting.

In the drawings:

FIG. 1 shows a fully assembled topiary structure formed chosen topiary components from a kit of such components, showing the chosen topiary shape of a bear.

FIG. 2 is an exploded view of a typical assembled topiary structure such as in FIG. 1, showing components of the kit to include a separable body half sections and separable half sections of chosen appendages configured to connect to formed apertures in the body portion of the topiary.

FIG. 3 depicts a first or front section of the body portion of the assemblable topiary structure adjacent an engageable second or rear section, and showing appendage apertures formed into the half sections which have mating connectors in registered portions to connect to mating connectors on any of a kit of engageable appendage components.

FIG. 4 shows a side perspective view of the engageable body sections of FIG. 3 and shows the apertures for both arms and legs or connection of similar appendage components from a kit such as in FIG. 5.

FIG. 5 shows a kit of engageable appendage components each of which is formed of two half sections which will nest with each other for shipping, and may be assembled for engagement to the apertures of an assembled body portion of the structure.

FIG. 6 shows two half sections of an assemblable appendage and shows complimentary cooperative fasteners in registered positions on each half portion, to engage with such on the other half potion.

FIG. 7 is a side perspective view of the two half sections of the body portion of the topiary structure such as in FIGS. 3-4, engaged and upright with apertures having bayonet style mating connectors ready for connection to chosen assembled appendages from a kit, such as shown in FIG. 5.

FIG. 8 depicts the half portions of the appendages of FIG. 6 where the complimentary fasteners on each half portion are engaged, and shows connecters positioned on one end to engage with mating connectors positioned upon the apertures of the formed body portion such as shown in FIG. 7.

FIG. 9 shows an assembled appendage such as in FIG. 8, where the connectors positioned on the end thereof are operatively engaged with mating connectors on the aperture in a permanent or preferably removable engagement therebetween.

FIG. 10 shows the two sections of a body portion of the system such as in FIG. 7 engaged with chosen appendages from a kit such as in FIG. 5, which are assembled and engaged to the apertures in the body portion, to form the shape of a rabbit.

FIG. 11 shows the two sections of a body portion of the topiary assembly system herein, such as in FIG. 7 engaged with chosen appendages from a kit such as in FIG. 5, which are assembled and engaged to appendage apertures to form the shape of a piglet.

FIG. 12 is a side view of the topiary assembled from the kit of components herein of FIG. 11 showing another view of the assembled three dimensional piglet and also showing the preferred unobstructed path through the axial passage of the leg and arm appendages into the interior cavity of the body portion.

FIG. 13 is a view of components of the topiary device showing the nesting of all components within their respective opposing half section, and the nesting of all components in a half section of the body enabling compact shipping.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation. The term substantially, where used, unless otherwise defined, means plus or minus twenty percent.

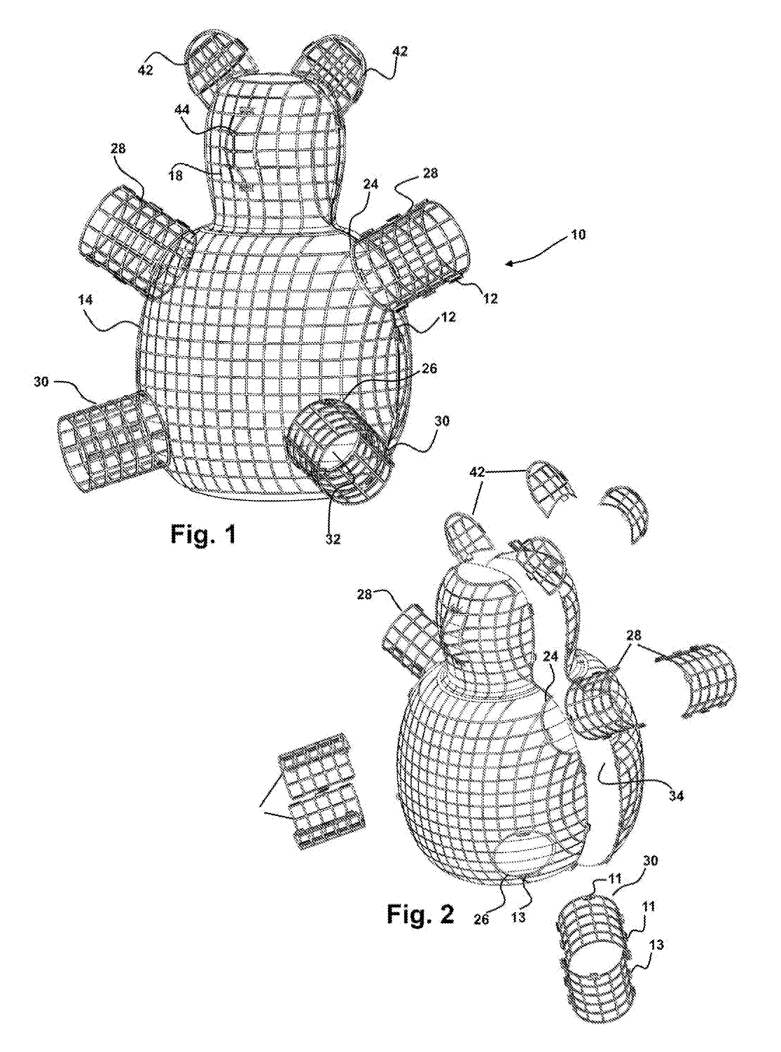

Now referring to drawings in FIGS. 1-13, wherein similar components are identified by like reference numerals, there is seen in FIG. 1 a fully assembled topiary structure device 10. Each such topiary device 10 is formed from user-chosen topiary components, which are available as a kit of such components. As shown in FIGS. 1 and 2 the assembled device 10 forms to a bear like three dimensional shape, from the engageable components which are all configured with removably engageable mating or complimentary connectors, to allow easy separation and assembly and shipping in a nested configuration. Such provides, as noted, for significant reduction in shipping costs and quick and easy on-site assembly.

The device 10 shown assembled in FIG. 1, as with all modes of the device 10 herein, is shown in FIG. 2, in an exploded view. Each assembled topiary device 10, herein, is formed of a plurality of assemblable topiary components from a kit of such. Each of the components is formed in a rigid mesh to allow plant growth therethrough. Each component also preferably features a first half section engageable to a second half section using complimentary fasteners one both.

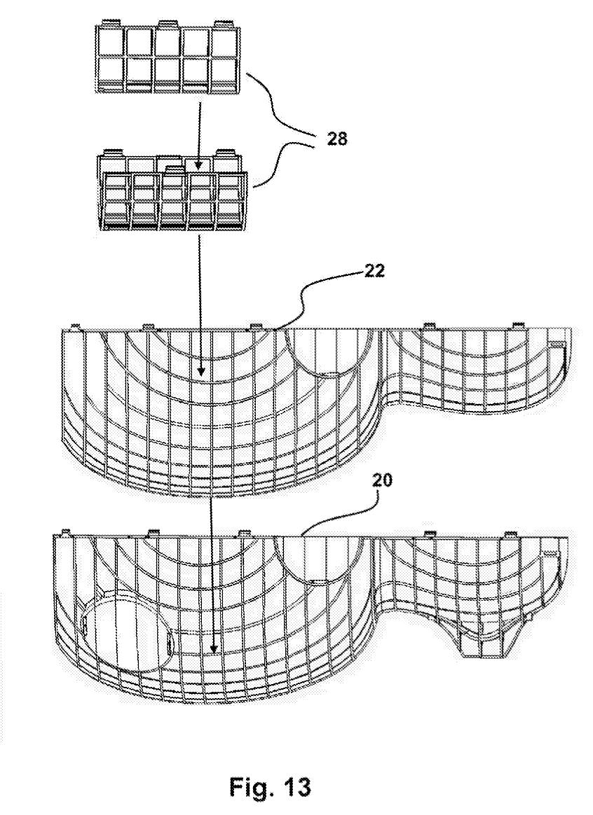

By complementary fasteners 12 is meant that a first half of the complimentary fastener 12 on one component is positioned to align with and removably engage with a second half of the complimentary fastener 12 on another component. In all modes of the device 10 herein, most, if not all of the separable components, are preferably formed of a first half section which will nest against a second half section for storage and shipment, which is shown, for example in FIG. 13. As noted, this is preferred to allow for shipping, easy assembly, and the provision of a wide variety of user chooseable appendages to engage to a generic body of the device 10, to render it in appearance to any of a large plurality of shapes.

As shown in FIGS. 1-4, each topiary device 10 includes a body portion 14 which, as shown, has a torso section 16 and a head section 18. Preferably the combination torso and head section, as well as the other components of the topiary device 10, are formed in their respective half sections of a mesh formed of metal, plastic, fiberglass, or other materials adapted for outdoor long term use as would occur to those skilled in the art.

As can be seen in FIGS. 1-4, the body portion, 14 as with other nesting parts of the device 10, is formed of a substantially rigid mesh in a shape defining a first half section 20, which is substantially a mirrored configuration of a second half section 22. By substantially is meant that they both have similar or mirrored curved shapes and dimensions and one half section will easily nest into the other half section.

In the exploded view of FIG. 2, can be seen in addition to the two half sections of the mesh body portion 14, are the different components which are engageable using complimentary fasteners 12 where one half of each fastener 12 is positioned upon one half section, and the other half of each mating fastener 12 is located in mating positions on the other half section of each component. The engageable components are also preferably formed of a rigid mesh to both hold their shape, and allow growth through openings in the openings in the mesh.

Included in the assembled body portion 14 are also first formed openings 24 which have complimentary fasteners 12 thereon, which mate with complimentary fasteners 12 located on each assembled arm 28. Also included in each assembled body portion 14 are second openings 26, which have fasteners 12 thereon which are complimentary to fasteners 12 located on one end of legs 30. The openings 24 may be left out in a less functional mode of the device 10, however they are preferred to allow for easy access to the interior of the formed device 10 for lighting and watering. Additionally, the formed openings 24 and 26, have been found to give the user, who may not be a sophisticated assembler, targets for positioning of the various appendages resulting in a significant decrease in assembly time.

Consequently, while the device 10 may be assembled without openings, by positioning mating fasteners 12 at the appropriate locations, however these openings 20 and 22, as noted, are especially preferred as they provide user targets, and an unobstructed pathway through the wall forming the body portion 14 whereby an axial passage 32 running through each arm 28 and leg 30 is in unobstructed communication with an interior cavity 34 formed within the assembled half sections of the body portion 14.

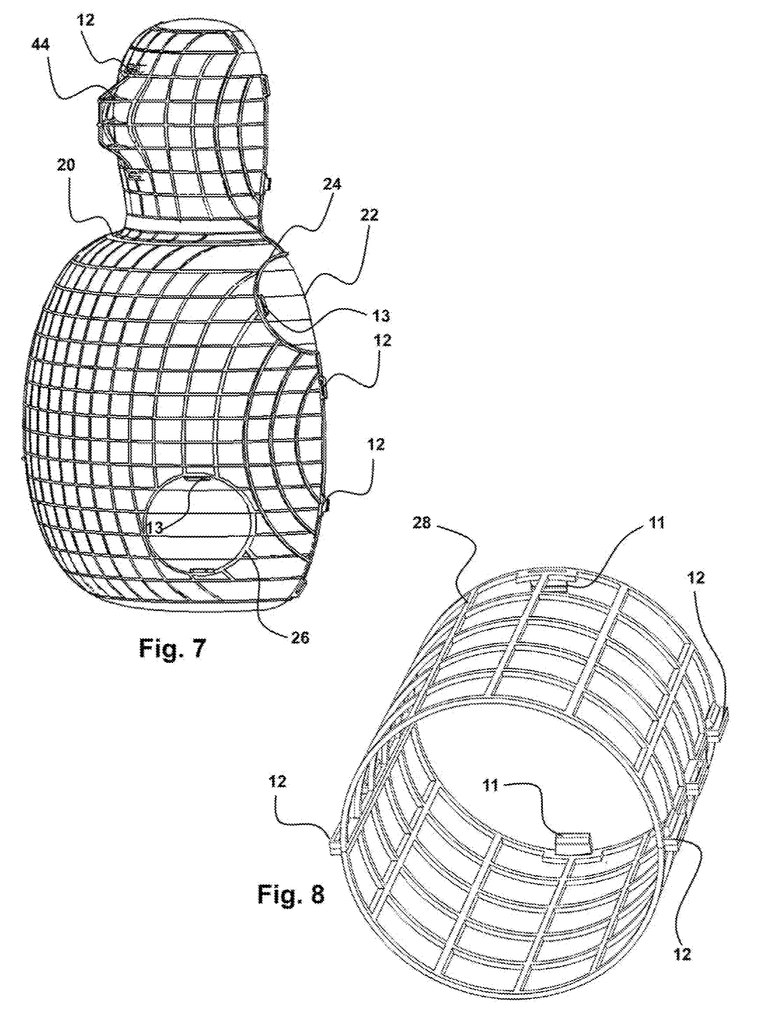

The complimentary fasteners 12 and their operation can be seen in FIGS. 6-8 where they are shown un engaged in FIG. 6-7 and operatively engaged in FIG. 8. As shown, a first fastener component with a projection 11 is engageable with a second fastener component opening 13. The projection 11 is compressible such that once passed through the opening 13 it expands and hold the complimentary fastener 12 in a removable engagement. The complementary fasteners 12 are very secure which is desirable for the long term the device 10 will occupy outdoors.

Disengagement of the fasteners 12, if required, can be accomplished by compressing the projection 11. Of course, other separable or permanent complimentary fasteners 12, formed of engageable fastener half portions as would occur to those skilled in the art may be employed such as any from the GRAINGER or other catalogs with fasteners. However, the bayonet style fasteners herein allow the user an especially easy engagement by simply aligning all the fastener halves on each piece, and pushing the part to be engaged to the body portion 14 toward the body portion 14. Consequently, such would be preferred for this ease of engagement in outdoor garden conditions where lighting and weather are an issue. The self-engaging complimentary fastener halves herein are also preferred because the user needs no tools, nor wires or crimpers or other non-attached, hard to use fasteners to attach the various components.

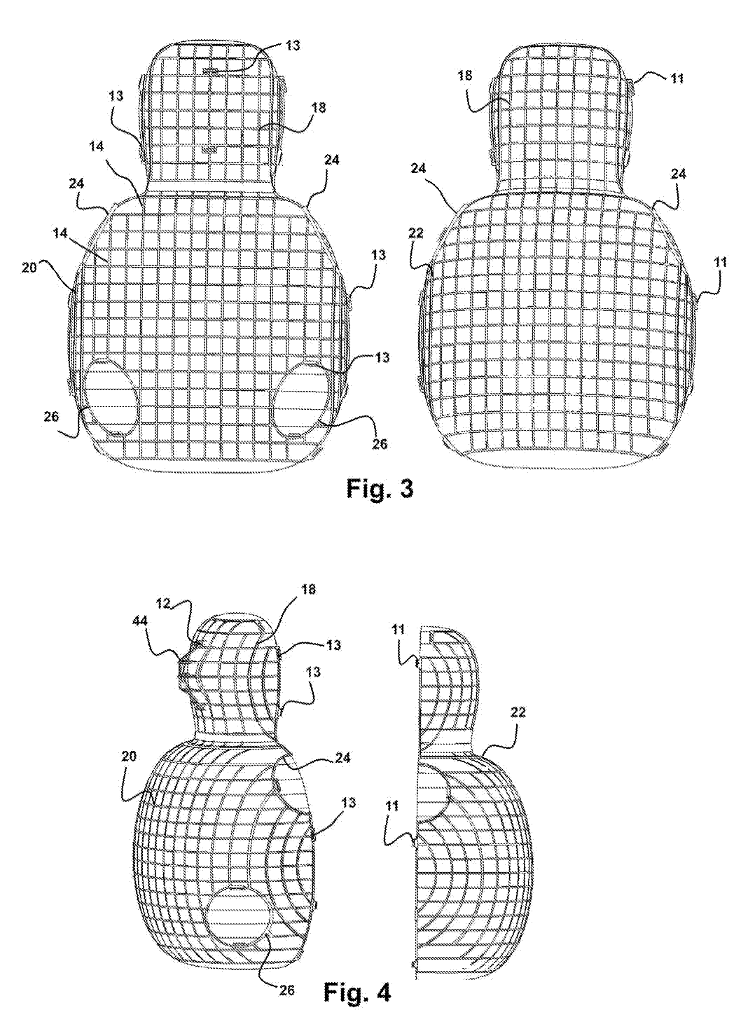

Shown in FIG. 3, is an overhead view of the first half section 20 and second half section 22 which engage to form the body portion 12 of the device 10 such as in FIGS. 1-2 and 10-12. As can be seen, the complimentary fasteners 12 are formed by the engagement of the projection 11 on one half of the fasteners 12 and the opening 13 of the other half of the complimentary fasteners 12 and hold the first half section 20 to the second half section 22, to form the body portion 14. Similar to FIG. 3, in FIG. 4 is shown the two half sections 20 and 22 of FIG. 3, in a perspective view.

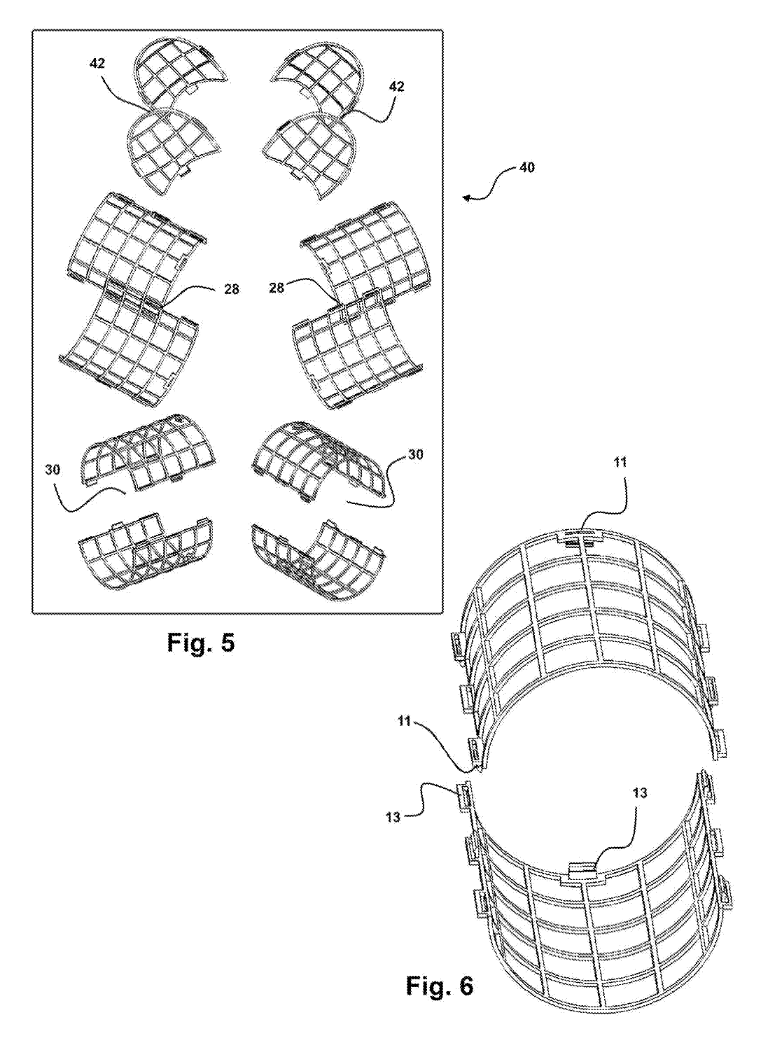

In FIG. 5 is depicted, an example of one mode of a kit 40 of appendage components which are made available to user, to choose from, to render the three dimensional shape of the finished device 10, to the desired shape. As shown, ears 42 can be provided in many different shapes in the kit 40 such as those in FIGS. 1,11, and 12. By appendage components is meant a kit of engageable arms and/or legs, and or ears, and/or noses, and/or other projecting appendages, which give the device 10 a recognizable shape of an object or animal.

Consequently in the kit of appendages shown for example in FIG. 5, other shapes for such as would occur to those skilled in the art for ears 42 which will change the overall perceived shape of the device 10 when attached. Also shown are arms 28 and legs 30, both of which would be part of an appendage kit 40 but which also can vary in shape and size to allow a changing of the shape of the finished device 10 to user requirements.

As shown, all of the arms 28, legs 30 and ears 42 are formed by first and second half sections, which will stack in a compact nesting fashion, and which when in such a nesting fashion, can be stacked within the internal cavity 34 of one of the first half section 20 or second half section 22 of the body portion 12, for compact shipping and storage. The first and second half sections of the components of the kit 40, are easily assembled by complimentary fasteners 12, which locate a first complimentary fastener or projection 11 on one half section which engages a second complimentary fastener which is shown here as formed openings 13 on the other half sections. While noted above, the arms and legs and other appendages in the kit 40 may be formed in single pieces instead of halves, however such will not best provide the nesting utility of the device 10 herein in all modes, and consequently half sections are preferred.

Also shown in FIG. 5 and larger in FIG. 6, the appendages from the kit 40, can have their respective half sections easily joined as all have mating portions of complimentary fasteners 12 which as can be seen in FIG. 6, currently are a first complimentary fastener or projection 11 which will engage the second complementary fastener such as an opening 13 located on the body portion 14, such as on a first opening 24 or second opening 26, or the appropriate registered position on the body portion 14.

FIG. 7 shows a side perspective view of the two half sections 20 and 22, of the body portion 14 of the topiary device 10 such as in FIGS. 3-4 and in other drawings herein. Shown are the engaged complimentary fasteners 12 as well as the first openings 24 and second openings 26 having mating connectors such as openings 13 ready for connection to the mating connector portions such as projections 11 on the chosen assembled appendages from a kit 40 shown by example in FIG. 5.

FIG. 8 shows an enlarged view of the typical engagement of the two half portions of the appendages available in the kit of FIG. 5. The complimentary first and second portions of each complimentary fastener 12 are engaged to connect the two half portions of the appendages available in the kit 40. When disengaged, the half sections of each appendage will nest in an adjacent positioning to each other, and be easily positioned within the internal cavity 34 of one half section of the body portion 14.

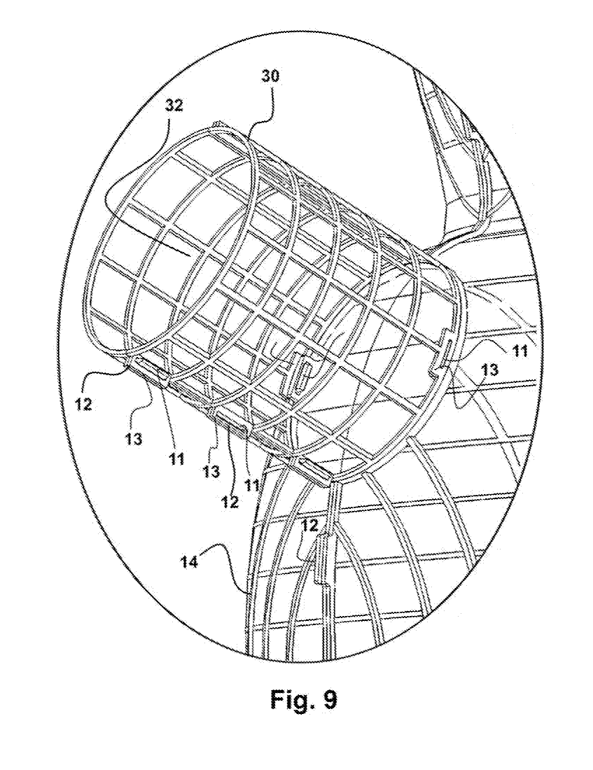

FIG. 9 shows a chosen appendage from the kit of appendages 40 of FIG. 5. As noted, FIG. 5 is depicted to show a kit 40 featuring various exemplars of various appendages which could be included in a kit of appendages 40 where each has one half of a complimentary fastener 12 thereon, which can be easily engaged to the other half of complimentary fasteners 12 located on the body portion 14. Particularly preferred, as noted for the arms 28 and legs 30 once assembled from their respective half portions, are engagement points on one of the first opening 24 or second opening 26 already shown and described in previous figures herein. This is preferred as noted to provide unobstructed passage or access through the mesh wall of the body portion 14 between the interior cavity 34 and axial passages 32 of the appendages such as the arms 28 and legs 30.

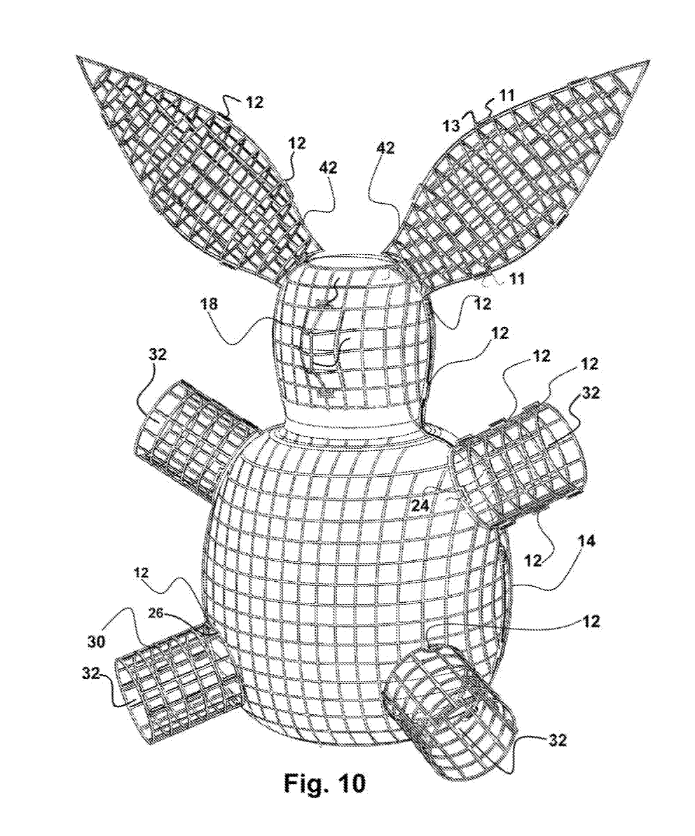

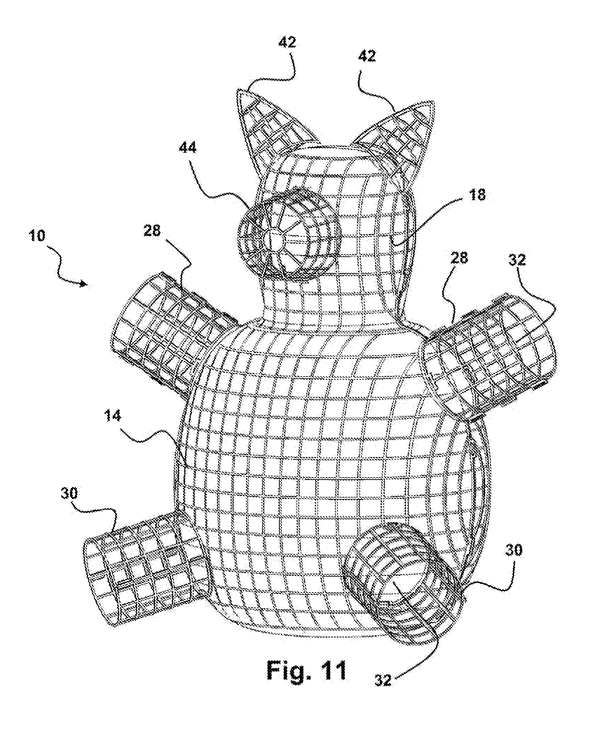

In FIG. 10 is shown that the member appendages of the kit 40 can include other shapes for the ears 42 such as the shown rabbit-like ears, and the appendages in the kit 40 can also include one or a plurality of noses 44. The nose 44 can be as in FIG. 10, or could be a trunk where an elephant shape is desired, or a snout type nose 44 shown in FIG. 11, or any other shape as would occur to those skilled in the art. The kit 40 of appendages could include any of the shown noses 44 herein or others not shown which will help the user form a chosen shape for their device 10. The nose 44 appendages from the kit 40 would engage the head section 18 of the body portion 14 using complimentary fasteners 12 in the same fashion noted herein for engagement of half sections of appendages and engagement thereof to the body portion 14.

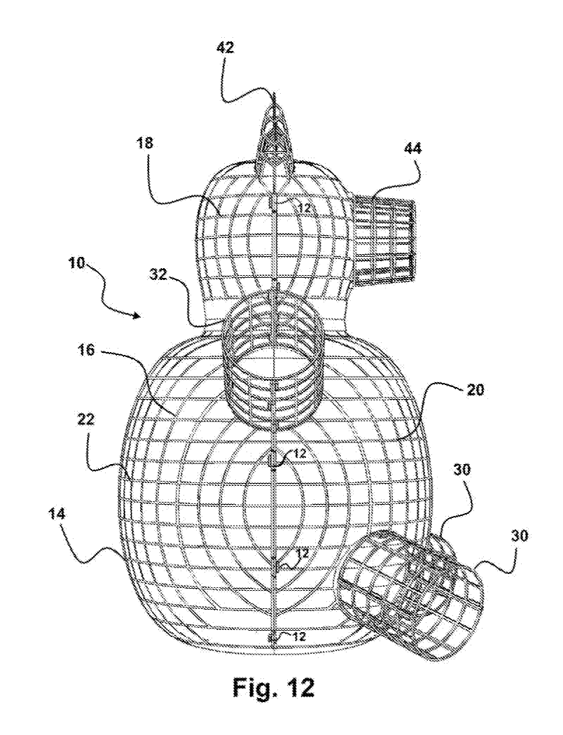

FIG. 11 shows the two half sections of a body portion 14 of the topiary device 10 herein, such as in FIG. 7 engaged by complimentary fasteners 12. Also shown are chosen appendages from a kit 40 of appendages such as in FIG. 5. As assembled the device 10 in FIG. 11 has user chosen appendages from a kit 40 of appendages which are engaged to the body portion 14 using the complimentary fasteners 12, to form the shape of a piglet. FIG. 12 is a side view of the topiary device 10 shown in FIG. 11.

Finally, shown in FIG. 13 is a view of components of the topiary device 10 herein, depicting the nesting or stacked positioning of the half portions forming the body as well as half sections forming the appendages completely within one cavity of the higher stacked body half section, and below the perimeter edge, in a nesting position. As shown, the two half sections of the arms 28 or the legs 30, can nest with each other and then be positioned within the half portion of the interior cavity 34 of the higher positioned half sections 20 and 22 of the body portion 14. Once they have been so positioned in a stacked nesting positioning with the appendages sitting below the perimeter edge of the interior cavity 34 of the stacked half sections of the body portion 14, this stacked nesting storage and shipping configuration significantly reduces package size for shipping and storage.

While all of the fundamental characteristics and features of the topiary structure assemblable from removably engageable components herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful kit assembled topiary system herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A user-assembled topiary apparatus, comprising:
a first body half section formed of a rigid mesh and having an exterior surface and having a first cavity therein surrounded by a first perimeter edge;
a second body half section formed of a rigid mesh and having an exterior surface and having a second cavity therein extending to a second perimeter edge;
said first body half section positionable within said second cavity of said second body half section to form a stacked configuration;
said first body half section being removably engageable to said body second half section in a removable engagement forming a body portion of a topiary structure;
said body portion having a body shape defined by curvatures of said exterior surface of both said first half body section and said second body half section while in said removable engagement;
a plurality of appendages each formed of a rigid mesh and each extending between a respective first end thereof to a respective second end thereof;
complimentary fasteners for engaging said first end of each of said plurality of appendages to said body portion at respective engaged positions thereon; and
whereby, said body with said plurality of appendages in said engaged positions thereon form said topiary structure to a shape resembling an animal or object on which plants can grow to said shape.

2. The user-assembled topiary apparatus of claim 1 additionally comprising:
each of said plurality of appendages formed of a first appendage half section having a first cavity on a first side and having an exterior surface on a second side which removably engageable with a second appendage half section having a second cavity formed on a first side thereof and an exterior surface on an opposite side thereof;
each respective said first appendage half section being stackable within said second cavity of said second appendage half section in a stacked positioning; and
all of said first appendage half sections while in said stacked positioning with respective said second appendage half sections, being positionable within an area of said first cavity of said first body half section and below said first perimeter edge.

3. The user-assembled topiary apparatus of claim 1 additionally comprising:
said complimentary fasteners for engaging said first end of each of said plurality of appendages to said body portion at respective engaged positions thereon are each formed of a first half fastener positioned on said body portion and a second half fastener located at said first end of each of said plurality of appendages.

4. The user-assembled topiary apparatus of claim 2 additionally comprising:
said complimentary fasteners for engaging said first end of each of said plurality of appendages to said body portion at respective engaged positions thereon are each formed of a first half fastener positioned on said body portion and a second half fastener located at said first end of each of said plurality of appendages.

5. The user-assembled topiary apparatus of claim 2 additionally comprising:
complimentary fasteners for engaging each respective first appendage half section to a respective second appendage half section in a said removable engagement thereto; and
each said complementary fastener having a first half portion thereof located on a respective said first appendage half section;
each said complimentary fastener having a second half portion thereof located on a respective second appendage half section.

6. The user-assembled topiary apparatus of claim 4 additionally comprising:
complimentary fasteners for engaging each respective first appendage half section to a respective second appendage half section in a said removable engagement thereto; and
each said complementary fastener having a first half portion thereof located on a respective said first appendage half section;
each said complimentary fastener having a second half portion thereof located on a respective second appendage half section.

7. The user-assembled topiary apparatus of claim 1 additionally comprising:
openings formed through said body portion at said engaged positions for said appendages thereto; and
said openings providing a passage through said body portion into an interior cavity of said body portion for passages running through said appendages.

8. The user-assembled topiary apparatus of claim 2 additionally comprising:
openings formed through said body portion at said engaged positions for said appendages thereto; and
said openings providing a passage through said body portion into an interior cavity of said body portion for passages running through said appendages.

9. The user-assembled topiary apparatus of claim 3 additionally comprising:
openings formed through said body portion at said engaged positions for said appendages thereto; and
said openings providing a passage through said body portion into an interior cavity of said body portion for passages running through said appendages.

10. The user-assembled topiary apparatus of claim 4 additionally comprising:
openings formed through said body portion at said engaged positions for said appendages thereto; and
said openings providing a passage through said body portion into an interior cavity of said body portion for passages running through said appendages.

11. The user-assembled topiary apparatus of claim 5 additionally comprising:
openings formed through said body portion at said engaged positions for said appendages thereto; and
said openings providing a passage through said body portion into an interior cavity of said body portion for passages running through said appendages.

12. The user-assembled topiary apparatus of claim 6 additionally comprising:
openings formed through said body portion at said engaged positions for said appendages thereto; and
said openings providing a passage through said body portion into an interior cavity of said body portion for passages running through said appendages.

13. The user-assembled topiary apparatus of claim 1 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.

14. The user-assembled topiary apparatus of claim 1 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.

15. The user-assembled topiary apparatus of claim 3 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.

16. The user-assembled topiary apparatus of claim 4 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.

17. The user-assembled topiary apparatus of claim 7 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.

18. The user-assembled topiary apparatus of claim 12 additionally comprising:
each of said plurality of appendages chooseable as a kit of said appendages from a plurality of kits of said appendages; and
each of said plurality of kits of said appendages including different respective said appendages shaped as ears, arms and legs of a different said animal, whereby said shape of said topiary structure is changeable to that of a different said animal by attachment of a different kit from said plurality of kits to said body portion.
